(19) United States
(12) Patent Application Publication
(10) Pub. No.: US 2004/0196211 A1
(43) Pub. Date: Oct. 7, 2004

(54) Method of operating multiple advertising and display devices, and suitable advertising and display device, center and system

(75) Inventor: Jurgen Keuthe, Berlin (DE)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 10/787,318

(22) Filed: Feb. 27, 2004

(30) Foreign Application Priority Data
Apr. 1, 2003 (EP) 03290821.2

(51) Int. Cl. G09G 5/00

(52) U.S. Cl. 345/1.1

(57) ABSTRACT

Method of operating multiple advertising and display devices with matrix-type image structure, in which in a centre a first information content to be displayed is entered, in which control information stating on which of the multiple advertising and display devices this first information content is to be displayed is entered there, in which from this first information content and multiple other information contents a data stream is formed, in which this data stream is distributed to the multiple advertising and display devices in a radio-like way, in which the control information is transmitted to at least one of the multiple advertising and display devices, and in which at least one of the multiple advertising and display devices receives the data stream and the control information, as well as an advertising and display device, a centre and a system.

### BACKGROUND OF THE INVENTION

The invention is based on a prioity application EP 03290821.2 which is hereby incoporated by reference.

The invention relates to concerns a method of operating multiple advertising and display devices with matrix-type image structure according to the method of operating multiple advertising and display devices with matrix-type image structure, wherein to an advertising and display device with a display unit with matrix-like image construction to display information contents which change over time, characterized in that to a centre for a system with multiple advertising and display devices with matrix-like image structure, and to such a system.

Advertising and display devices with changing contents are today more and more widely distributed. They are generally used exclusively for advertising particular products or exclusively to display passenger information in the case of public transport means. In sports grounds, they are often used for information about the current state of the game. Advertising, display and information of other kinds rarely mesh with each other. There is no provision at all for information by, for instance, the police or fire brigade.

Many advertising devices are not at all intended for displaying arbitrary contents. However, many have a matrix-like image structure, and are thus in principle capable of displaying any arbitrary content. Only these will be considered further here. But even then, the display of arbitrary contents usually fails because traditional advertising and display devices always form whole systems with a data network which is exclusively provided for them, and are connected to the centre of a particular operator. Access by others is not provided.

### SUMMARY OF THE INVENTION

The invention is based on the object of making it possible to use advertising and display devices with matrix-like image structure more flexibly.

According to the invention, this object is achieved by a method of operating multiple advertising and display devices with matrix-type image structure, wherein in a centre a first information content to be displayed is entered, wherein control information stating on which of the multiple advertising and display devices this first information content is to be displayed is entered there, wherein from this first information content and multiple other information contents a data stream is formed, wherein this data stream is distributed to the multiple advertising and display devices in a radio-like way, wherein the control information is transmitted to at least one of the multiple advertising and display devices, wherein at least one of the multiple advertising and display devices receives the data stream and the control information, wherein this advertising and display device analyses the control information for whether the first information content is to be displayed, and wherein this advertising and display device displays the first information content.

This object is further achieved by an advertising and display device with a display unit with matrix-like image construction to display information contents which change over time, the advertising and display device having first reception means to receive a data stream which includes multiple information contents to be displayed, the advertising and display device containing second reception means to receive control information, the advertising and display device containing a selection means, to select one information content from the multiple displayable information contents on the basis of the received control information, and the advertising and display device containing an activation means, to activate the display unit with matrix-like image construction with the selected information content.

This object is further achieved by a centre for a system with multiple advertising and display devices with matrix-like image structure, having first input means to input information contents which can be displayed, having preparation means to form a data stream out of multiple information contents which can be displayed, having transmission means to transmit the data stream to a facility which distributes this data stream in a radio-like way, containing second input means to input control information to select one of the information contents which can be displayed, and having second transmission means to transmit the control information to at least one of the multiple advertising and display devices.

This object is further achieved by a system with multiple advertising and display devices with matrix-like image structure, having multiple advertising and display devices and a centre.

The invention is based on the thought of supplying all the information contents to be displayed to multiple advertising and display devices (information panels) in a broadcast-like way (e.g. by digital television). The information contents are selected locally, but the selection is controlled by a centre. These information contents and the rules about the place and time of presentation are input via the Internet.

### BRIEF DESCRIPTION OF THE DRAWINGS

Further forms of the invention should be taken from the subclaims and the following description.

Below, the invention is explained in more detail with the help of the attached drawings:

FIG. 1 shows a system according to the invention, in which the method according to the invention can be carried out with advertising and display devices according to the invention.

FIG. 2 shows an advertising and display device according to the invention.

FIG. 3 shows a control unit of an advertising and display device according to the invention.

FIG. 4 shows a centre according to the invention.

### DETAILED DESCRIPTION OF THE DRAWINGS

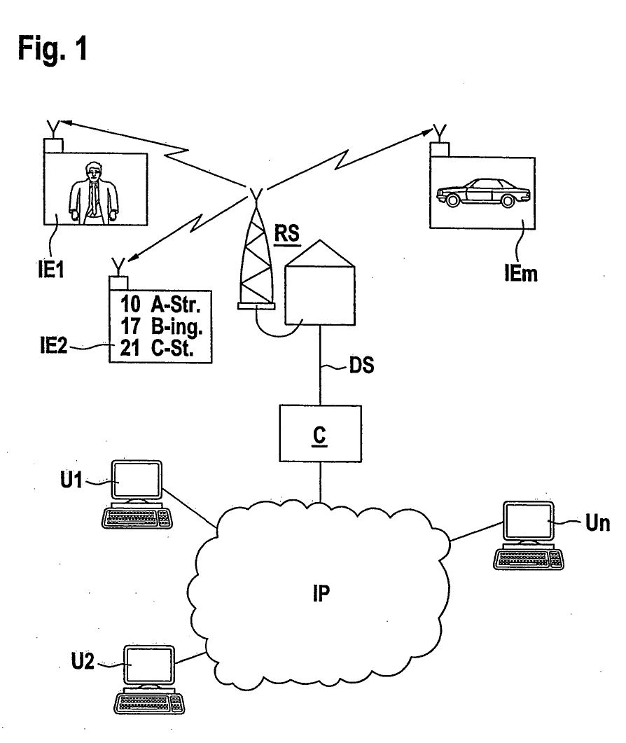

On the basis of FIG. 1, the system according to the invention and the method according to the invention are first described.

The system according to FIG. 1 has a series of advertising and display devices, of which devices IE1, IE2 and IEm are shown. The advertising and display devices IE1, IE2, . . . IEm are supplied with information by radio from a radio station RS. The radio station RS is shown as a combination of an aerial device and a broadcasting centre. They are connected to each other by cable. The system also has a centre C, which can be connected to a series of users via a data network, here the Internet IP. The users are represented by users U1, U2 and Un. The centre C transmits a data stream DS to the radio station RS. The radio station, the data network and the users are not considered to be part of the system according to the invention, but here they are used with it.

A user, for instance user U2, now wishes to switch an advertisement to various advertising and display devices which belong to the system. In principle, of course, the user can agree this with a human operator of the system operating company, using traditional media. However, the user preferably sets up a data connection, in the example via the Internet IP. The user then enters the desired information content to be displayed. This entry can be by transmitting this content in direct form, in whatever format. However, it can also be by reference to an information content which is already known, or which exists in another place in the Internet.

The user will also enter, preferably by the same route, the conditions in which the user wants to switch this advertisement on. The user will possibly agree with an operator in the centre by telephone about when, how long and where the relevant information content is to be displayed, and in what conditions. The more specific the wishes are, the greater is the probability that they collide with the wishes of other users. It is then necessary to go to alternatives. In the case of agreement with the operator, the operator must then enter the wishes at the centre. In practice, the operator will also use the route through the Internet.

However, in principle and advantageously, the operator's work can be transferred to the user in some cases. For instance, the user can fill in an Internet form, and send it together with the desired information content to the centre. Through a dialogue, which is automated on the side of the centre, it is possible to search for an alternative in the case of collisions. Such an automated dialogue can also include suggestions from the system or provision of a list of options (place and time) which are still free.

The conditions in which a particular information content is then to be displayed on at least one of the advertising and display devices IE1, IE2, . . . IEm are then prepared as control information.

According to the invention, it is now provided that the information content of this advertisement and the associated control information should be sent to the advertising and display devices, and it should be further processed there. For the information contents, a broadcast-type transfer is provided here. This can be done as part of a transmitted television signal, preferably of digital television. However, a television signal exclusively for this purpose can also be provided. In this way, shorter or longer video scenes can be transmitted and displayed.

These information contents must now be displayed on at least one of the advertising and display devices at the intended time. The information contents for other advertising and display devices and other times are transmitted in the same way. Preferably, a continuous data stream is formed from all the information contents, and transmitted to all the advertising and display devices in the described way.

It is not absolutely necessary that a time for display is also specified. In this case, a display would always be switched on just when the associated control information arrives. However, the system can be operated much more flexibly if rules can also be made about the times or time periods for display. For timetable information, it can be useful always to display it for a specified period before the arrival of the next train. Advertising spots today are often displayed in blocks, an advertising spot being displayed several times with a specified interval.

The more flexibly the facility works and the bigger the role of local initiators, the more difficult it is to keep track of the actual flow for accounting purposes. It can be useful here to capture the data which is required for accounting on site and report it back in a suitable way. If the medium for transmission of control information is mobile communications or a comparable broadcast service, it is also possible to report back with this medium.

Whether this signal, which is distributed by broadcast, is now distributed terrestrially or via satellite or cable, is not significant in principle. In any case, according to the invention a medium which is not primarily intended for this purpose, and to which access is possible in a simple way from every advertising and display device, should be used for distribution.

This data stream is now accessed by every advertising and display device, corresponding to the control information which applies to it. Obviously, this must be sent in advance by the centre C to these devices. Preferably, the control information for all advertising and display devices is combined in the same way as the individual information contents. This combined overall control signal is narrow-band compared with the rest of the data stream, and can be integrated into this data stream like an individual information content.

However, the control information can also be transmitted to the relevant advertising and display devices in a different way. For instance, it can be done at each individual device, in much the same way as an SMS (Short Message Service) in mobile communications. In this way, it is also possible to give the police or fire brigade the additional option of easily placing short display contents (“Traffic jam”, “Please clear the station”, “Tunnel blocked”) temporarily in the place of the previous information contents of a particular device.

Accounting with the users also takes place via the centre. Any filters which do not allow certain content should also advantageously be provided at this point. User behaviour on the one hand and the operator's tariff strategy on the other can be specified by appropriate rules which must be entered in advance, but this concerns mainly the commercial side of the invention.

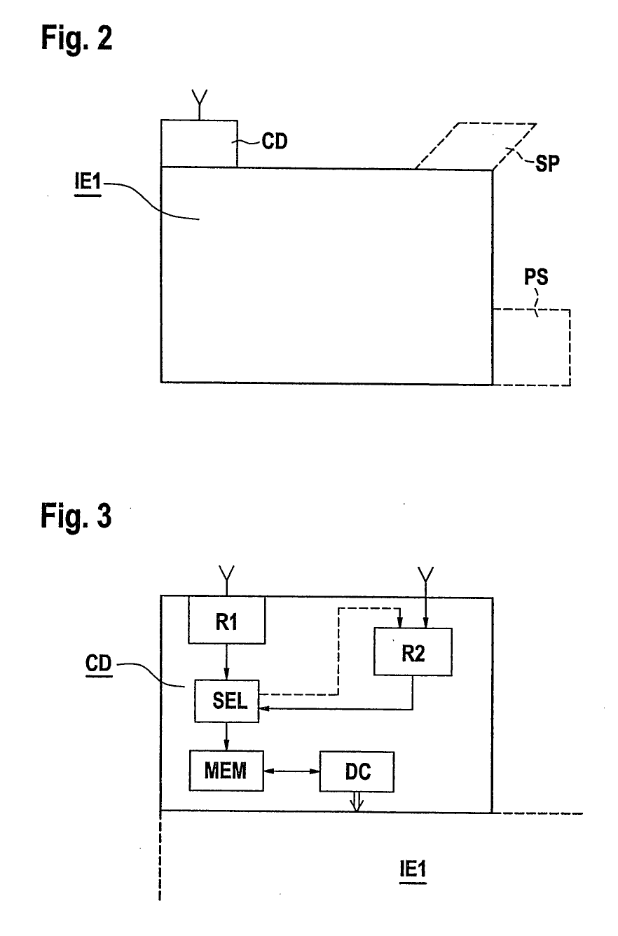

On the basis of FIG. 2, the overall structure of an advertising and display device according to the invention, here advertising and display device IE1, is presented briefly. Apart from the display surface, which is not described in more detail here, this device has a control unit CD, which is shown here at the top edge of the device because of the preferred radio reception. For the required power supply, a solar panel SP, also at the top edge, or alternatively a mains power supply PS is provided. Both are shown with dashed lines.

On the basis of FIG. 3, the control unit CD of the advertising and display device IE1 is described in more detail. The control unit CD has a first receiver R1, a selection circuit SEL, a memory MEM, a display controller DC and a second receiver R2.

The receiver R1 receives the data stream DS, which here comes via an aerial which is not described, from the centre C, here via the radio station RS, and passes it on to the selection circuit SEL. This data stream includes at least the information contents and in some circumstances also the control information. If the data stream also includes the control information, it is filtered out by the selection circuit SEL, and passed on to the receiver R2 on the path which is marked with dashes. The receiver R2 analyses it in such a way that it passes the selection control information, which is required to select the information contents from the data stream DS, to the selection circuit SEL on the path which is marked with a continuous line.

The information contents which are selected from the data stream DS on the basis of the control information are stored in the memory MEM, together with the information concerning the intended selection time, and displayed via the display controller DC at the intended time. If an immediate display is desired, the display time does not have to be stored with it. The display controller DC adapts the information contents to the display panel, in a suitable way which is known in itself.

The receiver R2 can receive the control information on the direct path, alternatively or additionally. For this purpose, in the drawing it is connected to its own aerial by a path which is marked with dashes.

In some circumstances, one control unit CD can control multiple spatially adjacent advertising and display devices, even with different information contents.

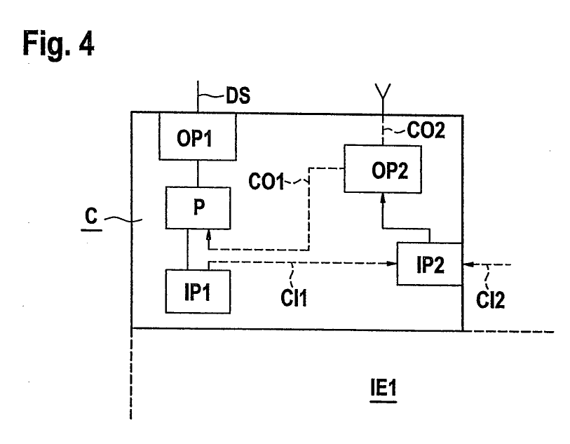

On the basis of FIG. 4, the structure of a service centre C is now described as an example. This has two input circuits IP1 and IP2 as the first and second input means, a preparation circuit P and two output circuits OP1 and OP2 as the first and second transmission means.

From the first input circuit IP1, a data path leads via the preparation circuit P to the output circuit OP1. The input of the first input circuit is preferably connected to the Internet. The second input circuit IP2 has a control input path CI1 from the first input circuit and a second control input path CI2 for an operator, which are either alternatives or mutually complementary. The second input circuit IP2 gives the control information to the second output circuit OP2. This gives it either via a control output path CO1 to the preparation circuit P, so that it is included in the data stream DS, or directly via a control output path CO2 to an aerial. Of course, the physical formats are different in the two cases.

1. Method of operating multiple advertising and display devices with matrix-type image structure, in which in a centre a first information content to be displayed is entered, wherein control information stating on which of the multiple advertising and display devices this first information content is to be displayed is entered there, wherein from this first information content and multiple other information contents a data stream is formed, wherein this data stream is distributed to the multiple advertising and display devices in a radio-like way, wherein the control information is transmitted to at least one of the multiple advertising and display devices, wherein at least one of the multiple advertising and display devices receives the data stream and the control information, wherein this advertising and display device analyses the control information for whether the first information content is to be displayed, and wherein this advertising and display device displays the first information content.

2. Advertising and display device with a display unit with matrix-like image construction to display information contents which change over time, the advertising and display device having first reception means to receive a data stream which includes multiple information contents to be displayed, the advertising and display device containing second reception means to receive control information, the advertising and display device containing a selection means, to select one information content from the multiple displayable information contents on the basis of the received control information, and the advertising and display device containing an activation means, to activate the display unit with matrix-like image construction with the selected information content.

3. Centre for a system with multiple advertising and display devices with matrix-like image structure, having first input means to input information contents which can be displayed, having preparation means to form a data stream out of multiple information contents which can be displayed, having transmission means to transmit the data stream to a facility which distributes this data stream in a radio-like way, containing second input means to input control information to select one of the information contents which can be displayed, and having second transmission means to transmit the control information to at least one of the multiple advertising and display devices.

4. System with multiple advertising and display devices with matrix-like image structure, having multiple advertising and display devices according to claim 2 and a centre having first input means to input information contents which can be displayed, having preparation means to form a data stream out of multiple information contents which can be displayed, having transmission means to transmit the data stream to a facility which distributes this data stream in a radio-like way, containing second input means to input control information to select one of the information contents which can be displayed, and having second transmission means to transmit the control information to at least one of the multiple advertising and display devices.

5. Method according to claim 1, characterized in that the control information is inserted into the data stream which is to be distributed in a radio-like way.

6. Method according to claim 5, characterized in that the control information for several or all advertising and display devices is combined into an overall control information data stream, and inserted as such into the data stream which is to be distributed in a radio-like way.

7. Method according to claim 1, characterized in that the control information also includes information about the time or period when the associated information content is to be displayed.
